(19) United States
(12) Patent Application Publication
(10) Pub. No.: US 2025/0123408 A1
(43) Pub. Date: Apr. 17, 2025

(54) PROCESSING A GNSS SIGNAL AND WIPING OFF A DATA BIT BASED ON DOPPLER ESTIMATES

(71) Applicant: u-blox AG, Thalwil (CH)

(72) Inventors: Zhenlan CHENG, Thalwil (CH); Maxim KOEHLER, Thalwil (CH)

(21) Appl. No.: 18/918,541

(22) Filed: Oct. 17, 2024

(30) Foreign Application Priority Data
Oct. 17, 2023 (EP) 23204225.9
Oct. 17, 2023 (EP) 23204226.7
Jun. 28, 2024 (EP) 24185523.8

(51) Int. Cl. G01S 19/37; G01S 19/29; G01S 19/30

(52) U.S. Cl. CPC G01S 19/37; G01S 19/29; G01S 19/30

(57) ABSTRACT

A method and apparatus are provided for processing a GNSS signal received at a receiver. The method comprises mixing a local carrier signal with samples of the GNSS signal to generate carrier-free signal samples. It further comprises: correlating the carrier-free signal samples with a local spreading code to generate a complex-valued correlation result; and wiping off at least one of the data bits from the complex-valued correlation result, to produce a data-free complex-valued correlation result. A carrier phase of the local carrier signal is controlled based on a Doppler estimate for the GNSS signal, wherein the Doppler estimate is based at least in part on inertial measurements made at the receiver.

### CROSS-REFERENCE TO RELATED APPLICATIONS

This application claims priority to European Application Nos. EP23204225.9, filed on Oct. 17, 2023, EP23204226.7, filed on Oct. 17, 2023 and EP24185523.8, filed on Jun. 28, 2024, the contents of which are incorporated herein by reference in their entirety.

### FIELD OF THE INVENTION

The present invention relates to Global Navigation Satellite Systems (GNSS). In particular, it relates to using Doppler estimates to support bit wipe-off and/or long coherent integration of GNSS signals.

### BACKGROUND OF THE INVENTION

Techniques for GNSS positioning are well known in the art. Existing GNSS include the Global Positioning System (GPS), Galileo, GLONASS, and BeiDou Navigation Satellite System (BDS), also referred to herein as simply “BeiDou”. Each GNSS comprises a constellation of satellites, also known in the art as “space vehicles” (SVs), which orbit the earth. Typically, each SV transmits a number of satellite signals. These are received by a GNSS receiver whose position it is desired to calculate. The GNSS receiver can make a number of ranging measurements using the signals, to derive information about the distance between the receiver and respective satellites. When a sufficient number of measurements can be made, the receiver's position can then be calculated by multilateration.

In order to make a GNSS measurement, it is necessary to acquire and track the relevant GNSS signal. While this may be relatively easy under open sky conditions, it may become more challenging under more difficult signal reception conditions. Multipath conditions may present particular difficulties. The accuracy of the position calculation depends on the accuracy of the ranging measurements. However, when significant multipath is present, the GNSS receiver may acquire and track a reflected version of the satellite signal, rather than the direct “line-of-sight” (LOS) signal. The reflected version is likely to have a different path length and therefore will produce a different ranging measurement, which may corrupt or degrade the accuracy of the resulting position fix.

Under challenging signal reception conditions, the LoS may be received weakly. Therefore, in order to successfully acquire and track the LoS signal, the receiver sensitivity should be as high as possible. Increasing the receiver sensitivity increases the likelihood of being able to detect the LoS GNSS signal, which in turn increases the likelihood of being able to reject multipath.

One way of increasing sensitivity is to increase the coherent integration time at the receiver.

### SUMMARY OF THE INVENTION

It would be desirable to make the receiver more sensitive to GNSS signals. In particular, it would be desirable to increase the maximum coherent integration time that may be used by the receiver. However, as the coherent integration time is increased, the integration becomes more susceptible to changes in the speed or direction of travel of the GNSS receiver. Sudden acceleration may cause the receiver to lose its lock on the GNSS signal. Even if lock is not lost, the effect on the calculations may be such that the benefit of increasing the coherent integration period is lost. For example, it may be desirable to wipe off data bits of the GNSS signal, in order to support longer coherent integration times. However, sudden acceleration may cause bit-detection to fail-especially in challenging reception conditions. This, in turn, may corrupt the wipe-off process, leading to phase errors in the signal samples that are to be coherently integrated. In a conventional carrier tracking loop, these phase errors caused by erroneous bit-detection can interfere with accurate tracking. This can lead to an undesirable feedback effect—the erroneous bit detection corrupts the carrier phase estimation, and the erroneous carrier phase estimation further corrupts the bit detection process—and so on—rapidly leading to a loss of signal lock.

The present inventors have recognised that knowledge of changes in speed and orientation can be used to mitigate the negative effects of dynamic motion on the coherent integration. This can include mitigating the negative effects of motion on the bit detection and wipe off. Inertial measurements can be used to compensate for the motion, when detecting GNSS signals, detecting and wiping-off bits, and obtaining GNSS measurements.

A method and apparatus are provided for processing a GNSS signal received at a receiver. The method comprises mixing a local carrier signal with samples of the GNSS signal to generate carrier-free signal samples. It further comprises: correlating the carrier-free signal samples with a local spreading code to generate a complex-valued correlation result; and wiping off at least one of the data bits from the complex-valued correlation result, to produce a data-free complex-valued correlation result. A carrier phase of the local carrier signal is controlled based on a Doppler estimate for the GNSS signal, wherein the Doppler estimate is based at least in part on inertial measurements made at the receiver.

According to one aspect, there is provided a method of processing a GNSS signal received at a receiver, the GNSS signal containing a data message comprising a plurality of data bits, the method comprising:
obtaining samples of the GNSS signal;
generating a local carrier signal;
generating a local spreading code;
mixing the local carrier signal with the samples to generate carrier-free signal samples;
correlating the carrier-free signal samples with the local spreading code to generate a complex-valued correlation result;
wiping off at least one of the data bits from the complex-valued correlation result, to produce a data-free complex-valued correlation result; and
processing the data-free complex-valued correlation result to produce at least one of: an indication of whether the GNSS signal is detected or not; and a GNSS measurement for the current epoch,
wherein a carrier phase of the local carrier signal is controlled based on a Doppler estimate for the GNSS signal, wherein the Doppler estimate is based on inertial measurements made at the receiver.

In an example, the GNSS signal does not include a pilot signal. The GNSS signal may be a GPS L1CA or BDS B1I signal, for example.

The carrier phase of the local carrier signal may be controlled such that it is not based directly on the result of any data bit detection derived from the GNSS signal. Any influence of the data bit detection on the carrier phase may be indirect and not immediate. For example, a GNSS measurement for the current epoch (produced by processing the data free complex valued correlation result) may be combined with GNSS measurements derived from other GNSS signals as well as information derived from inertial measurements. The combined information may influence the carrier phase in a later epoch.

Optionally, the carrier phase of the local carrier signal is not controlled using a carrier tracking loop based on the GNSS signal.

The Doppler estimate may be derived based on the inertial measurements and a navigation solution calculated previously at the receiver. The receiver may calculate/update a delay estimate and Doppler estimate for each visible SV, according to a line-of-sight (LoS) vector between the receiver (e.g. an antenna of the receiver) and that SV. The navigation solution may comprise a position, velocity, time (PVT) solution. At least the velocity solution may be calculated at a high rate (for example at a rate of at least 50 Hz).

The carrier phase of the local carrier signal may be controlled by controlling the frequency of the local carrier signal (since the phase can be advanced or retarded by increasing or decreasing the frequency, respectively). The frequency may be updated each time the Doppler estimate is updated (for example, at a rate of at least 50 Hz). This can help the carrier phase of the local carrier signal to more accurately track the carrier phase of the received GNSS signal.

Decoupling the carrier phase of the local carrier signal from (previous) bit detection results and/or from any carrier phase estimate based on the carrier-free signal samples can help to prevent errors in bit detection (or other errors in carrier phase estimation) from interfering with carrier signal tracking. It would be advantageous to break the error propagation between the carrier frequency/phase estimation and bit detection in the Costas loop. This can lead to a much more reliable bit detection, with the bit-error rate approaching the additive white Gaussian noise (AWGN) bound, especially at low carrier to noise density ratios. This can also facilitate longer coherent integration times. These attributes may be particularly advantageous when signal reception conditions are poor—for example, when carrier to noise density ratio is relatively low. In such conditions, carrier signal tracking based on a tracking loop may become unreliable.

The local carrier signal may also be referred to as a carrier replica or replica carrier signal. The local spreading code may also be referred to as a spreading code replica or replica spreading code.

The indication of whether the GNSS signal is detected or not may be useful in an acquisition phase or a re-acquisition phase. Re-acquisition may be required when a car exits a tunnel for instance, or in a hot-start scenario when the receiver is turned off for a short time and restarted while the timing can still be maintained precisely. In both cases, the lock on the GNSS signal is lost, but the receiver is able to predict the delay and Doppler quite precisely for the near future.

Processing the (data-free) complex-valued correlation result optionally comprises performing a discrete Fourier transform (DFT) on it. The GNSS measurement may be based on a result of the DFT. For example, the GNSS measurement may comprise a Doppler frequency and code-phase delay which are derived by finding a peak in one or more of the DFT results.

In some instances, the Doppler estimate may be derived from a navigation solution for the previous epoch. The navigation solution may be provided by a positioning engine (PE). The positioning engine may be configured to process GNSS measurements to produce the navigation solution. The navigation solution may comprise a state vector. The positioning engine may be configured to estimate the state vector at each epoch. The state vector may comprise a plurality of state variables, the state variables including one or more Doppler estimates, and optionally including one or more of: position variables, velocity variables, and time variables.

The method may further comprise detecting a data bit based on the complex-valued correlation result. The data bit may be detected based on a complex phase angle of the complex-valued correlation result.

The method may further comprise obtaining a data bit detected at a reference receiver. The receiver and the reference receiver may be components in a system configured to perform differential GNSS (DGNSS) positioning. In this case, the receiver may be (or may be part of) a “rover” device in the DGNSS system. The reference receiver may be configured to provide measurements and/or corrections to the receiver of the rover.

Typically, the reference receiver is in the same geographical region as the receiver. For example, the receiver may be located less than 400 km, optionally less than 100 km, 50 km, or 10 km from the reference receiver The reference receiver may be stationary. Obtaining the data bit may comprise receiving the data bit from the reference receiver directly or indirectly—for example, via direct or indirect wireless communications. Here, “direct” wireless communication should be understood as meaning wireless communication between two devices without intermediary—for example, as in a peer-to-peer network. “Indirect” wireless communication refers to communication between two devices via one or more intermediary devices. Therefore, when using indirect wireless communication, the data bit may be received wirelessly from an intermediary device, which received it directly or indirectly (via wired or wireless communication) from the reference receiver. In some examples, the wireless communication may comprise radio frequency (RF) communication.

It may be expected that the reference receiver has good signal reception conditions—for example, because of its location, lack of movement, and surroundings. For instance, the reference receiver may be located in an elevated position with a good view of the sky. It may therefore be able to receive GNSS signals more reliably than the (rover) receiver. Consequently, bit detection may be more reliable at the reference receiver than at the (rover) receiver.

Wiping off at least one of the data bits from the complex-valued correlation result may be based on the detected data bit.

Data bit wipe-off can facilitate greater sensitivity of the receiver, in particular in difficult signal reception conditions, for example by facilitating longer coherent integration times. It should be understood that the “detected data bit” here may refer to a data bit detected at the receiver based on the complex-valued correlation result, or to a data bit detected at a reference receiver and obtained from it.

The method may comprise: identifying a subframe of the data message that is associated with the detected data bit; determining that the subframe is not a repeating subframe that has been buffered previously; and wiping off the at least one of the data bits from the complex-valued correlation result based on the detected data bit, responsive to said determining.

The subframe in question may be either (i) a non-repeating subframe; or (ii) a repeating subframe that has not been buffered.

Data bits may be wiped off differently for different subframes of the data message. This can help to increase the range of circumstances in which wipe-off is possible and/or may help to enhance the accuracy of wipe-off.

Data-bit wipe off based on a detected data bit may facilitate wipe-off when the subframe is not a repeated, identical instance of one that has been buffered previously (and therefore the data bit cannot be determined from knowledge of a previous part of the data message).

The method may comprise: identifying a subframe of the data message that is associated with the detected data bit; determining a signal quality metric associated with the detected data bit; and determining that the subframe is not a repeating subframe that has been buffered previously, and that the signal quality metric exceeds a signal quality threshold; and wiping off the at least one of the data bits from the complex-valued correlation result based on the detected data bit, responsive to said determining.

If the signal quality metric does not exceed the signal quality threshold, data bit wipe-off may comprise squaring the complex-valued correlation result. However, this may involve a squaring loss. When the signal quality metric exceeds the threshold, wiping off based on the detected data bit may lead to more accurate results.

The method may further comprise storing the detected data bit in a buffer. The buffer may be a subframe buffer configured to store the detected bits of one or more subframes. Storing detected data bits in the buffer can enable the receiver to (re-) use knowledge of them later, for data-bit wipe-off.

The method may comprise: identifying a subframe of the data message that is associated with the detected data bit; determining that the subframe is a repeating subframe; and storing the detected data bit in the buffer, responsive to said determining.

For a repeating subframe, storing detected data bits in the buffer can enable the receiver to (re-) use the knowledge of those data bits when later decoding (and/or wiping off) a subsequent (identical) instance of the repeating subframe. The repeating subframe may have a repetition-period shorter than a predetermined threshold period (for example, one minute).

The method may comprise: identifying a subframe of the data message that is associated with the detected data bit; determining a signal quality metric associated with the detected data bit; determining that the subframe is a repeating subframe and that the signal quality metric exceeds a signal quality threshold; and storing the detected data bit in the buffer, responsive to said determining.

The signal quality metric may comprise a carrier signal to noise density ratio, for example. Taking into account the signal quality metric can help to ensure that only correctly detected data bits are used to support later wipe-off. This can help to improve the accuracy of wipe-off, and thereby enhance the sensitivity of the receiver.

The method may further comprise retrieving a stored data bit from a buffer, wherein wiping off at least one of the data bits from the complex-valued correlation result is based on the retrieved data bit.

(Re-) using previously buffered data bits for wipe-off can improve the accuracy of wipe-off—for example, if the signal reception conditions have deteriorated since the data bits were buffered, then the buffered data bits may be more accurate than currently detected data bits.

In greater detail, the method may comprise: at a first epoch, detecting a data bit based on a first complex-valued correlation result and storing the detected data bit in a buffer; and at a second, later epoch, retrieving the stored data bit from the buffer, and wiping off at least one of the data bits from a second complex-valued correlation result, based on the retrieved data bit.

The storing in the buffer may be done based on any of the conditions already summarised above. In particular, a subframe of the data message that is associated with the detected data bit may be a repeating subframe (optionally with a repetition-period shorter than a predetermined threshold period). The first epoch may be associated with a first instance of the repeating subframe; the second epoch may be associated with a second instance of the repeating subframe.

The method may comprise: identifying a subframe of the data message that is associated with the at least one data bit to be wiped off; determining that the subframe is a repeating subframe that has been buffered previously; and wiping off the at least one of the data bits from the complex-valued correlation result based on the retrieved data bit, responsive to said determining.

The data bits of a repeating subframe are repeated in multiple iterations of the subframe (during a predetermined validity interval). This makes repeating subframes particularly amenable to the present method.

The method may comprise: identifying a subframe of the data message that is associated with the at least one data bit to be wiped off; determining a signal quality metric; determining that the subframe is a repeating subframe that has been buffered previously and that the signal quality metric does not exceed a signal quality threshold; and wiping off the at least one of the data bits from the complex-valued correlation result based on the retrieved data bit, responsive to said determining.

Wipe-off based on retrieved buffered data bits may be particularly advantageous when a repeating subframe is encountered and the signal quality is less than or equal to a threshold. If the signal quality was greater than the threshold, wipe-off by detecting the current data bits might be adequate. However, when the signal quality is low, wipe-off by detecting the current data bits might be unreliable. By making the use of the retrieved data bits conditional on low signal quality, examples of the present method can switch to using buffered data bits in the situations where that brings the biggest performance benefit.

In some examples, the method may comprise: identifying a subframe of the data message that is associated with the at least one data bit to be wiped off; determining whether the subframe is a repeating subframe that has been buffered previously; responsive to determining that the subframe is a repeating subframe that has been buffered previously: retrieving a stored data bit from a buffer, and wiping off the at least one of the data bits from the complex-valued correlation result based on the retrieved data bit; and responsive to determining that the subframe is not a repeating subframe that has been buffered previously: detecting a data bit based on the complex-valued correlation result (or obtaining a data bit detected at a reference receiver); and wiping off the at least one of the data bits from the complex-valued correlation result based on the detected data bit.

Optionally, in some examples, the method may comprise: identifying a subframe of the data message that is associated with the at least one data bit to be wiped off; determining whether the subframe is a repeating subframe that has been buffered previously; determining a signal quality metric; determining whether the signal quality metric exceeds a signal quality threshold; responsive to determining that the subframe is a repeating subframe that has been buffered previously: retrieving a stored data bit from a buffer, and wiping off the at least one of the data bits from the complex-valued correlation result based on the retrieved data bit; and responsive to determining that the subframe is not a repeating subframe that has been buffered previously and the signal quality metric exceeds the signal quality threshold: detecting a data bit based on the complex-valued correlation result (or obtaining a data bit detected at a reference receiver); and wiping off the at least one of the data bits from the complex-valued correlation result based on the detected data bit.

(If the subframe is not a repeating subframe that has been buffered previously and the signal quality metric does not exceed the signal quality threshold, wiping off the at least one of the data bits may comprise squaring.)

Optionally, in some examples, the method may comprise: identifying a subframe of the data message that is associated with the at least one data bit to be wiped off; determining whether the subframe is a repeating subframe that has been buffered previously; determining a signal quality metric; determining whether the signal quality metric exceeds a signal quality threshold; responsive to determining that the subframe is a repeating subframe that has been buffered previously and the signal quality metric does not exceed the signal quality threshold: retrieving a stored data bit from a buffer, and wiping off the at least one of the data bits from the complex-valued correlation result based on the retrieved data bit; responsive to determining that the subframe is a repeating subframe that has been buffered previously and the signal quality metric exceeds the signal quality threshold: detecting a data bit based on the complex-valued correlation result (or obtaining a data bit detected at a reference receiver); wiping off the at least one of the data bits from the complex-valued correlation result based on the detected data bit; and storing the detected data bit in the buffer and responsive to determining that the subframe is not a repeating subframe that has been buffered previously and the signal quality metric exceeds the signal quality threshold: detecting a data bit based on the complex-valued correlation result (or obtaining a data bit detected at a reference receiver); and wiping off the at least one of the data bits from the complex-valued correlation result based on the detected data bit.

Correlating the carrier-free signal samples with the local spreading code optionally comprises: correlating the carrier-free signal samples with an early version of the local spreading code, to generate an early complex-valued correlation result; correlating the carrier-free signal samples with a prompt version of the local spreading code, to generate a prompt complex-valued correlation result; and correlating the carrier-free signal samples with a late version of the local spreading code, to generate a late complex-valued correlation result.

This approach can enable greater robustness to slight errors in the code phase of the local spreading code. The coherent integration (in particular, the DFT) may be applied separately to the results of the late, prompt, and early correlations.

The method may comprise: determining a first signal quality metric associated with the early complex-valued correlation result; determining a second signal quality metric associated with the prompt complex-valued correlation result; determining a third signal quality metric associated with the late complex-valued correlation result; identifying the highest signal quality metric among the first, second, third signal quality metrics; and detecting a data bit based on the complex-valued correlation result that is associated with the highest signal quality metric.

For example, if the first signal quality metric is the highest signal quality metric, the method may comprise detecting the data bit based on the early complex-valued correlation result. If the second signal quality metric is the highest signal quality metric, the method may comprise detecting the data bit based on the prompt complex-valued correlation result. If the third signal quality metric is the highest signal quality metric, the method may comprise detecting the data bit based on the late complex-valued correlation result.

Using the correlation “tap” with the highest signal quality metric can increase the accuracy of data bit detection.

Each signal quality metric may be based on a complex magnitude of the associated complex-valued correlation result. Detecting the data bit may be based on a complex phase angle of the complex-valued correlation result.

A code phase of the local spreading code may be controlled based on the Doppler estimate. This can enable not only the local carrier signal but also the local spreading code to dynamically track the received GNSS signal, based on the inertial measurements. The code phase may be updated each time the Doppler estimate is updated (for example, at a rate of at least 50 Hz).

Processing the data-free complex-valued correlation results optionally comprises coherently integrating the data-free complex-valued correlation results.

The coherent integration may help to increase the sensitivity of the receiver to weak GNSS signals. The coherently integrating may comprise coherently integrating over a time interval that is longer than a duration of a data bit—and, optionally, longer than the duration of two, three, or more data bits.

The GNSS measurement may be based on a result of the coherent integration.

The coherent integration may comprise integrating over at least 0.25 s, at least 0.5 s, at least 1 s, or at least 2 s. It may comprise integrating over less than 10 s, less than 5 s, or less than 4 s. (All combinations of these endpoints are hereby disclosed.)

The GNSS measurement may comprise a code phase of the GNSS signal, and processing the data-free complex-valued correlation results optionally comprises determining the code phase of the GNSS signal based on the data-free complex-valued correlation results. Wiping off the data bits using the methods summarised here may assist in more accurately determining the code phase.

The method may further comprise calculating a navigation solution based on the determined code phase. Wiping off the data bits using the methods summarised here may assist in more accurately determining the navigation solution.

The Doppler estimate may be one of a sequence of Doppler estimates, wherein the sequence of Doppler estimates is produced at a frequency greater than or equal to a baud rate of the data message. Frequent updates to the Doppler estimate can assist in tracking the received GNSS signal more closely.

The method may further comprise: estimating a rate of change of the Doppler estimate; and extrapolating a second Doppler estimate from the Doppler estimate, wherein the second Doppler estimate is extrapolated based on the estimated rate of change, wherein the carrier phase of the local spreading code is controlled based on the second Doppler estimate.

This can help to compensate for a latency in the Doppler estimate, thereby increasing the accuracy of the Doppler estimate and consequently improving the tracking of the GNSS signal.

Also provided is a computer program comprising computer program code configured to cause one or more physical computing devices to perform all the steps of a method as claimed in any one of the preceding claims when said computer program is run on said one or more physical computing devices.

The one or more physical computing devices may comprise or consist of one or more processors of a GNSS receiver. The computer program may be stored on a computer-readable medium (optionally non-transitory).

Also provided is a Global Navigation Satellite System, hereinafter GNSS, receiver, configured to process a GNSS signal, the GNSS receiver comprising a measurement engine configured to:
obtain samples of the GNSS signal;
generate a local carrier signal;
generate a local spreading code;
mix the local carrier signal with the samples to generate carrier-free signal samples;
correlate the carrier-free signal samples with the local spreading code to generate a complex-valued correlation result;
wipe off at least one of the data bits from the complex-valued correlation result, to produce a data-free complex-valued correlation result; and
process the data-free complex-valued correlation result to produce at least one of: an indication of whether the GNSS signal is detected or not; and a GNSS measurement for the current epoch,
wherein a carrier phase of the local carrier signal is controlled based on a Doppler estimate for the GNSS signal, wherein the Doppler estimate is based on inertial measurements made at the receiver.

The GNSS receiver may further comprise: an RF front-end, for receiving the GNSS signal, and for down-converting and digitising the GNSS signal; and a mixer for wiping off a residual carrier from the signal. The GNSS receiver may further comprise an intermediate-frequency (IF) processing unit, for processing the signal down-converted from RF to IF by the RF front-end. An output of the RF front-end may be coupled to an input of the intermediate-frequency processing unit. An output of the IF processing unit may be coupled to an input of the mixer.

The GNSS receiver may further comprise at least a first correlator, coupled to an output of the mixer, configured to wipe off a spreading code of the GNSS signal. The first correlator may be part of a bank of correlators, including early, prompt, and late correlators.

One or more outputs of the correlator(s) may be coupled to a bit detector and one or more respective multipliers configured to wipe off bits from the output(s) of the correlator(s).

The GNSS receiver may further comprise a buffer for storing detected bits—in particular bits of repeating subframes. The GNSS receiver may further comprise a switch configured to selectively couple the one or more multipliers to either the bit-detector or the buffer.

The GNSS receiver may further comprise a code generator, configured to generate the local spreading code. The code generator may be controlled at least in part based on the Doppler estimates.

The code generator may comprise a numerically controlled oscillator (NCO), configured to generate a clock signal for generating the local spreading code.

The code generator may provide an input to the correlator to enable it to wipe off the spreading code of the GNSS signal.

The GNSS receiver may further comprise a carrier generator, configured to generate a local carrier signal for wiping off the residual carrier from the GNSS signal. The carrier generator may comprise an NCO configured to generate the local carrier signal.

### BRIEF DESCRIPTION OF THE DRAWINGS

The invention will now be described by way of example with reference to the accompanying drawings, in which:

FIG. 1 is a block diagram of a GNSS receiver operating in a first mode of operation, according to an example (not presently claimed in isolation);

FIG. 2 is a block diagram of a GNSS receiver operating in a second mode of operation, according to an example;

FIG. 3 is a block diagram of a GNSS receiver operating in a third mode of operation, according to an example;

FIG. 4 is a block diagram of a variant of the GNSS receiver illustrated in FIG. 2, according to an example;

FIG. 5 is a block diagram of a variant of the GNSS receiver illustrated in FIG. 3, according to an example;

FIG. 6 is a graph illustrating Doppler frequency extrapolation according to an example; and

FIG. 7 is a block diagram of a DGNSS positioning system according to an example.

It should be noted that these figures are diagrammatic and not drawn to scale.

### DETAILED DESCRIPTION

Reference will now be made in detail to examples according to the present disclosure, which are illustrated in the accompanying drawings. The described examples should not be construed as being limited to the descriptions given in this section; the examples may have different forms.

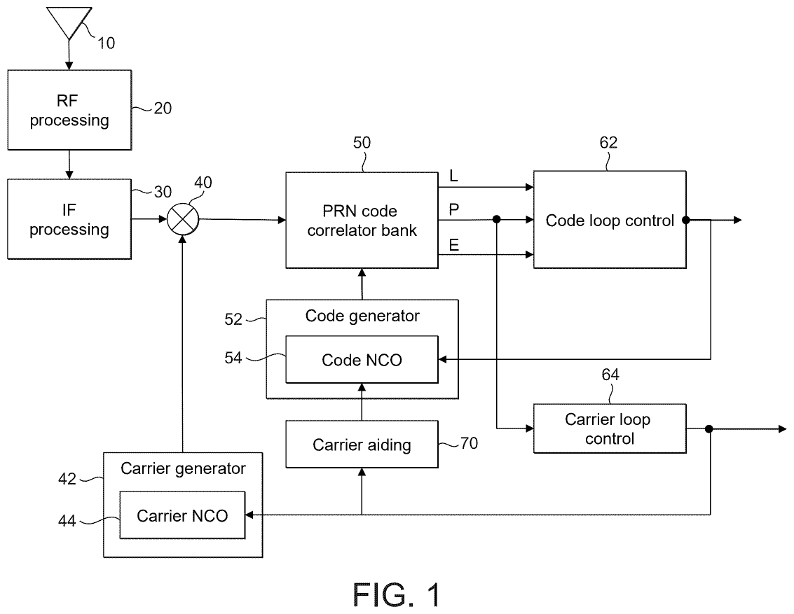

FIG. 1 is a block diagram of a GNSS receiver operating in a first mode of operation, according to an example (not presently claimed). This particular mode of operation reflects a conventional approach to signal-tracking. This conventional approach may be suitable under good signal reception conditions (for example, open sky conditions with little or no multipath).

The GNSS receiver is configured to receive satellite signals from GPS satellites. It may alternatively or additionally be configured to receive satellite signals from other constellations (for example, Galileo and BeiDou). The GNSS receiver comprises an antenna 10 for receiving satellite signals. An RF front-end 20, coupled to the antenna 10, is configured to down-convert and digitise the satellite signals received via the antenna 10. The RF front-end essentially conditions the signals for subsequent signal processing. Other typical tasks performed by the front-end include filtering, amplification and automatic gain control. The satellite signals received at the RF front-end 20 via the antenna 10 include an L1C/A signal.

The GNSS receiver further comprises an intermediate frequency (IF) processing unit 30, configured to process the satellite signals converted from radio frequency (RF) to IF in the RF front-end. The output of the IF processing unit 30 is coupled to an input of a mixer 40. The other input of the mixer 40 receives a local carrier wave, hereafter replica carrier signal, generated to replicate the carrier frequency and phase of the incoming signal. The replica carrier signal is a digital sinusoidal signal generated by a carrier generator 42. In this way, the mixer 40 is configured to wipe off, i.e. remove, any residual carrier, e.g. offset caused by the Doppler effect, from the incoming signal, by mixing the incoming signal with the replica carrier signal (in other words, calculating the product of the incoming signal and the replica carrier signal). In the present example, it will be assumed that the intermediate frequency is (approximately) zero. Although the carrier of the satellite signal is already removed before the incoming signal reaches mixer 40, there will be a (small) constant remaining IF and a varying carrier offset caused by the relative motion between the satellite and GNSS receiver. The carrier generator 42 comprises a numerically controlled oscillator (NCO) 44 configured to generate the replica carrier signal.

The output of the mixer 40 is provided as input to a bank 50 of correlators comprising three correlators. Each correlator comprises a multiplier and an integrate—and—dump (I/D) unit (not shown in FIG. 1). The output of each multiplier is provided as input to the respective integrate-and-dump (I/D) unit. Each multiplier multiplies the input signal by a replica spreading code. Each I/D unit calculates the sum of the resulting product values, over a suitable dwell. The dwell defines the length of a coherent integration within the correlator and corresponds an integer number of iterations (most commonly one iteration) of a spreading code used to modulate the GNSS signal. The bank of correlators includes an “early” (E) correlator, a “prompt” (P) correlator; and a “late” (L) correlator. As their names suggest, these three correlators use differently shifted versions of the replica spreading code. The replica spreading code is a binary pseudo-random noise (PRN) signal, and is generated by a code generator 52, which operates under the control of code loop controller 62. The code loop controller 62 receives the outputs of the three I/D units. It should be understood that the use of three correlators is merely illustrative. In many examples, there may be more than three correlators. In particular, there may be multiple “early” correlators, each with a different delay (shift) of the replica spreading code. Likewise, there may be multiple “late” correlators, each with a different delay (shift) of the replica spreading code. According to one implementation, there are four “early” correlators and four “late” correlators, in addition to one prompt correlator—that is, nine correlators in total.

Depending on which of the correlators (E, P, L) has the maximum output value for the current dwell, the controller 62 determines whether to adjust (for example, increment or decrement) the code phase delay control signal, which it provides to the code generator 52.

The code generator 52 is a signal code generator for the relevant GNSS signal. It comprises an NCO 54, which is configured to generate a clock signal for generating the replica spreading code for the GNSS signal. The NCO is controlled partly by the code phase delay control signal from the code loop controller 62 and partly based on frequency estimates generated by a carrier loop controller 64.

In this way, the bank of correlators, together with the code loop controller 62, carrier loop controller 64, and the code generator 52, function as a code phase tracking loop—in other words, a delay locked loop (DLL)—for the GNSS signal. The code phase tracking loop ensures that the code phase of the replica spreading code used by the “P” correlator tracks the actual code phase of the received other L1 signal with as little delay as possible.

The outputs of the I/D units within the bank 50 of correlators consist of complex-valued samples, also referred to as in-phase and quadrature samples (I/Q samples). In particular, the output of the I/D unit for the prompt (P) correlator represents I/Q samples of the GNSS signal. When implemented in hardware, each correlator (as with other hardware blocks), will include separate I- and Q-branches. That is, there will be a multiplier and an I/D unit for the in-phase (I) samples, and another multiplier and I/D unit for the quadrature-phase (Q) samples. Nevertheless, for simplicity, it is more convenient to conceptualise these as a single multiplier and a single I/D unit, having complex outputs, and that is how they will be described here.

The I/Q samples from the prompt (“P”) correlator output are provided to the carrier loop controller 64. The carrier loop controller 64 estimates the carrier frequency and carrier phase of the GNSS signal. It outputs the estimate as a carrier control signal, which is fed back to control the NCO 44 of the carrier generator 42. In providing this feedback, the carrier loop controller 64 implements a carrier tracking loop for the GNSS signal, ensuring that the frequency (and phase) of the replica carrier signal (generated by the carrier generator 42) tracks the actual frequency (and phase) of the carrier of the received L1 signal as closely as possible. This enables the GNSS receiver to take account of Doppler shift, due to the relative motion between the receiver and satellite. By controlling the frequency of the NCO in the carrier generator 42, both the frequency and phase of the replica carrier signal are controlled to match the frequency and phase of the residual carrier. (The phase of the replica carrier signal is advanced by increasing the frequency; the phase is retarded by decreasing the frequency.) Effectively, this implements a phase locked loop (PLL), tracking the residual carrier frequency and phase.

In the present implementation, the code loop controller 62 and the carrier loop controller 64 produce updates at the same rate—for example, 50 Hz. That is, they both operate on the same control period—in this example, 20 ms.

As well as updating the NCO 54 of the code generator 52 based on the code phase measurements produced by the code loop controller 62, it may be advantageous to update the chipping rate (and thereby code phase) of the NCO 54 based on the output of the carrier loop controller 64. Carrier aiding block 70 converts the output of the carrier loop controller 64 (which is effectively an estimate of Doppler frequency) into a chipping rate control value for the code NCO 54. The code NCO 54 runs at the specified chipping rate over the course of the control period (e.g., 20 ms). The chipping rate thereby influences the evolution of the code phase of the replica spreading code. The chipping rate control value is a down-scaled value from the Doppler estimate, based on the constant ratio of nominal carrier frequency to nominal chipping rate. If the code loop controller 62 detects a change/error in the code phase, it updates the code phase delay control signal accordingly, in the next control period. This control of the code phase is added to the cumulative effect of the chipping rate control.

Note that, in contrast to the carrier NCO 44, the code NCO 54 has two inputs-one for chipping rate control (from carrier aiding block 70, based on the Doppler estimate from the carrier loop controller 64) and one for code phase control (from the code loop controller 62). They are controlled independently. The chipping rate control determines the chipping rate. The code phase control determines the initial code phase of the control period. As a result, unlike the carrier phase, governed by the PLL described previously, above (for tracking the carrier frequency and phase), the code phase is not necessarily continuous at the boundary between control periods.

The components described above enable the GNSS receiver to track the GNSS signal in frequency and phase of the carrier as well as code phase. The code tracking loop and the carrier loop form a “measurement engine” that includes blocks 40-70.

In tracking mode, the output of the code loop controller 62 provides a real-time code phase measurement. Likewise, the output of the carrier loop controller 64 provides a real-time Doppler measurement. This code phase measurement and Doppler measurement are provided to a positioning engine (not shown in FIG. 1) which combines them with GNSS measurements from other GNSS signals to calculate a navigation solution (including a position fix). In acquisition mode, the code loop controller 62 can detect whether a GNSS signal has been acquired successfully, or whether the tracking loop is in effect tracking noise. This can be done by comparing the correlation results on the early, late, and prompt taps. When a GNSS signal is present, the magnitude of the correlation output on the prompt tap is significantly greater than the respective magnitudes on the early and late taps.

Demodulation/bit-detection is not illustrated in the simplified block diagram of FIG. 1. However, it should be understood that this is typically also performed, in practice, when receiving GNSS signals. When tracking a pilot sequence, there is no need for bit detection. When tracking the remainder of the GNSS signal, bit detection can be performed by examining phase changes from symbol to symbol on the prompt correlator output.

According to one aspect of the present disclosure, the tracking scheme of FIG. 1 is used when the GNSS receiver determines that signal reception conditions are good (at least for the GNSS signal in question). For example, the GNSS receiver may determine that C/No is greater than 37 dB-Hz, or that carrier phase lock is intact, or that the residual is below a predetermined threshold (or may determine that a combination of two or more of these criteria are met). The residual is the difference between (i) the estimated distance from the receiver to the respective satellite and (ii) the actual range measurement. When the residual is low, it indicates good consistency between the range measurement for the current satellite of interest and those for the other satellites.

Note that the decision about which mode to use can be made independently for each GNSS signal that is being tracked by the receiver. (FIG. 1 illustrates the tracking method for one GNSS signal, but it should be understood that the receiver will typically track several GNSS signals simultaneously, in order to produce a navigation solution.)

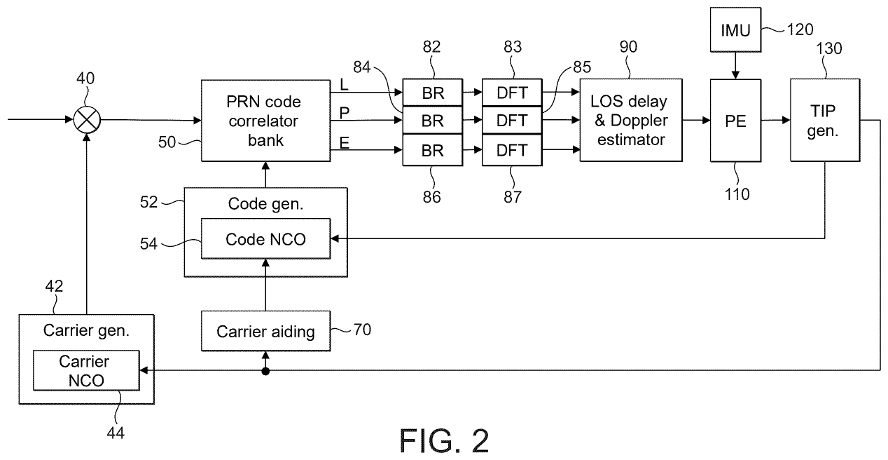

FIG. 2 is a block diagram of a GNSS receiver operating in a second mode of operation, according to an example (not presently claimed). The antenna 10, RF front-end 20, and IF processing unit 30 are omitted, for simplicity. They are the same as in the example of FIG. 1. The mixer 40, bank 50 of correlators, carrier generator 42, code generator 52, and carrier aiding block 70 operate in the same way as in FIG. 1, and will not be further described for this reason.

The operation mode illustrated in FIG. 2 differs from that illustrated in FIG. 1 by the way in which the carrier and chipping code of the GNSS signal are tracked. In the operation mode illustrated in FIG. 2, there is no feedback loop within the measurement engine itself. Instead, feedback to control the carrier NCO 44 and the code NCO 54 is provided from a positioning engine (PE) 110, which is responsible for calculating the navigation solution.

For the operation mode shown in FIG. 2, the outputs of the late, prompt, and early taps of the bank 50 of correlators are provided as inputs to respective bit removal (BR) blocks 82, 84, and 86. When receiving a part of the GNSS signal that contains data (for example, a navigation message), the bit removal blocks 82, 84, 86 wipe off the detected data bit by multiplying the complex correlator output by 1 or −1, as appropriate. When receiving a part of the GNSS signal that contains a pilot sequence, there is no need for bit detection, since the bit sequence of the pilot signal is known in advance.

The output of each bit removal block 82, 84, 86 is provided as input to a respective discrete Fourier transform (DFT) block 83, 85, 87. Each DFT block calculates a Fourier transform of the complex correlator outputs, over a defined coherent integration interval. The outputs of the DFT blocks 83, 85, 87 are provided as input to a line-of-sight (LoS) delay and Doppler estimator 90. The estimator 90 uses the information from the Fourier transforms to estimate a carrier phase and code phase of the GNSS signal.

The collective output of the DFT blocks 83, 85, 87 forms a two-dimensional matrix spanning a range of frequencies and a range of code-phase delays. In time variant channels, each multipath component typically possesses a Doppler and delay value that are different to the LoS values. In this delay-frequency matrix, a correlation triangle shows up at a specific Doppler value, with the peak of the triangle indicating the vicinity of delay and Doppler of a multipath component. By inspecting the matrix, several such peaks in the delay-frequency grid can be identified. The peak with the shortest time-of-arrival is detected as the line-of-sight path. When this is done, the taps on both sides of the correlation triangle are interpolated to give an estimate of the delay.

When the GNSS signal is being tracked accurately (and in the absence of fast dynamics) the LoS component should remain aligned with the “prompt” tap, with a Doppler frequency of zero. Any deviation of the code phase of the local spreading code from the code phase of the received GNSS signal will cause either the early or the late correlator tap to show an output with a greater magnitude than the prompt tap. Meanwhile, any deviation of the carrier frequency of the local carrier signal from the carrier frequency of the received GNSS signal will show up in the Fourier transform as a peak at a nonzero frequency.

The output of the estimator 90 corresponds to the output of the code loop controller 62 and the carrier loop controller 64 of FIG. 1. However, in the mode of operation illustrated in FIG. 2, the output of the estimator is not used directly to control the carrier generator 42 or the code generator 52. Instead, the output of the estimator 90 is provided as one of a number of inputs to the positioning engine 110. The positioning engine 110 also receives input from an inertial measurement unit (IMU) 120. One output of the positioning engine is a navigation solution, including estimates of position, velocity, time (PVT), and other state variables. The navigation solution is produced once per epoch and is passed to a “Tracking Intelligence Provider” (TIP) generator 130. The positioning engine 110 also outputs more frequent estimates of Doppler frequency, based on the inertial measurements that have been received since the most recent navigation solution. These Doppler frequency estimates are also output to the TIP generator. By way of example, the interval between epochs may be 1 s; therefore, the navigation solution may be output at a frequency of 1 Hz. The interval between Doppler estimates may be 20 ms; thus, the Doppler estimates may be output at a frequency of 50 Hz.

The TIP generator 130 converts the outputs of the positioning engine 110 into a code phase delay control signal for the code generator 52 and a carrier control signal for the carrier generator 42. To do this, the TIP generator 130 compares the current satellite positions with the current PVT solution from the positioning engine 110. From this comparison, the TIP generator predicts the delay and Doppler along the line-of-sight vector from the receiver to each of the satellites.

The code phase delay control signal is updated at the lower rate (for example, 1 Hz). This is because the code phase estimates are produced as part of the navigation solution once per epoch. The carrier control signal is updated at the higher rate, based on the more frequent Doppler estimates. Note that, although the code phase delay control signal is only updated at the lower rate (e.g., 1 Hz), the code phase of the code generator 52 is updated at the higher rate (e.g., 50 Hz). This is because the carrier aiding unit 70 updates the code generator 52 continually in the interval between epochs, at the higher rate, based on the higher rate Doppler estimates. In this way, the high-rate Doppler estimates can help to compensate for acceleration and high-order dynamics of the receiver during the coherent integration by the correlator bank and DFT blocks. Note, however, that the code phase of the code NCO is re-initialised at the start of each epoch based exclusively on the code phase delay control signal. In other words, the evolution of the code phase over the preceding epoch due to the cumulative influence of the carrier aiding block 70 does not affect the setting of the code phase at the start of the next epoch.

The measurement engine in FIG. 2 comprises blocks 40-90 (but not blocks 110, 120, 130). The output of the measurement engine is the output of the estimator 90. The positioning engine 110 receives corresponding inputs from multiple measurement engines-one for each GNSS signal that is being tracked. Typically, at least four signals from different satellites will be tracked, in order to support the calculation of the navigation solution. The positioning engine 110 combines the information provided by the GNSS measurements from the various measurement engines with the information provided by inertial measurements from the IMU 120. To do this, the positioning engine 110 uses a Kalman filter or other state estimator. The output of the state estimator includes the position, velocity, and time (PVT) solution. As mentioned above, the TIP generator 130 predicts the Doppler frequency and code phase for each GNSS signal based on the PVT solution and corresponding satellite LoS vectors. Note that, in some embodiments, the functionality of the TIP generator 130 may be merged into the positioning engine 110. For example, the positioning engine 110 may output state estimates for Doppler frequency and code phase for each satellite.

The mode of operation illustrated in FIG. 2 may be particularly suitable in difficult signal reception conditions. Completing the tracking loops through the positioning engine 110, helps to make the feedback to the code generator 52 and carrier generator 42 as robust and stable as possible. In situations where the tracking lock on one weak GNSS signal might otherwise be lost by the respective measurement engine, if it were working in isolation, the information provided by the other measurement engines (and the IMU 120) can enable continued tracking of the weak GNSS signal.

At the same time, because the tracking can keep a lock on the GNSS signal even in challenging signal reception conditions (and even in cases of fast dynamics, thanks to the use of the inertial measurements), the coherent integration time of the bank 50 of correlators and the subsequent DFT blocks 83, 85, 87 can be increased. This in turn increases the sensitivity of the measurement engine, enabling it to acquire and track weaker signals. In one example according to the present disclosure, the coherent integration time of the DFT blocks is 1 s.

A sequence of operations performed for each epoch will now be described in greater detail. Once per epoch, the positioning engine 110 provides code phase and Doppler input from the navigation solution. This is used to set the NCOs 44 and 54. The bank 50 of correlators begins producing millisecond samples. The positioning engine 110 provides high-rate Doppler input many times per epoch (for example 50 times per epoch, in the present example). Each time fresh Doppler input is provided, the NCOs 44 and 54 are set based on it. (The code NCO 54 is set via the carrier aiding unit 70; the carrier NCO is set directly.) The bank 50 of correlators continues producing millisecond samples. These are input to the DFT blocks 83, 85, 87 to calculate the DFT. After the Fourier Transforms are produced by the DFT blocks 83, 85, 87, they are evaluated by the estimator 90.

Optionally, the millisecond samples can be pre-integrated as soon as they are available, in order to begin calculating the DFT in a pipelined fashion. Alternatively, the millisecond samples can be stored until enough samples are available for a complete coherent integration period (e.g., 1 s) and the DFT can then be calculated using the complete set of samples.

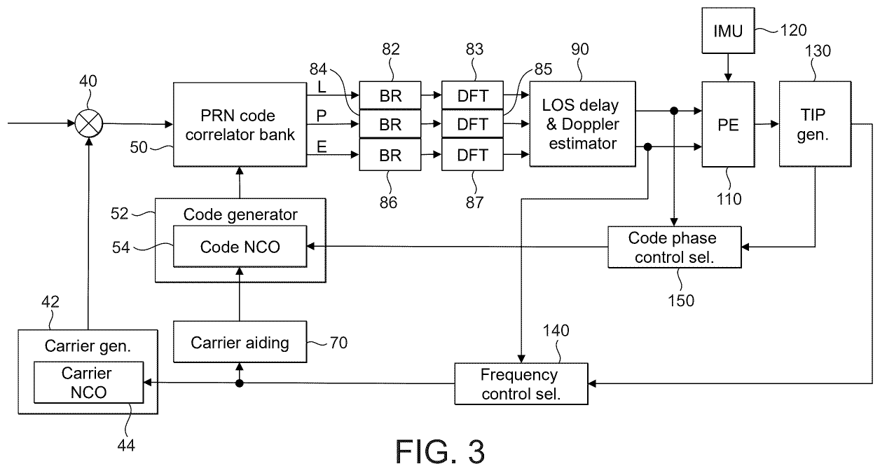

FIG. 3 is a block diagram of a GNSS receiver operating in a third mode of operation, according to an example. The third mode of operation is essentially a hybrid of the first two modes. It is most easily understood by comparing FIG. 3 with FIG. 2. As with FIG. 2, the antenna, RF front-end and IF processing unit are omitted for simplicity. The operation mode of FIG. 3 relies on all the same components as FIG. 2, operating in the same way. This includes the mixer 40, bank 50 of correlators, carrier generator 42, code generator 52, carrier aiding block 70, bit removal blocks 82, 84, 86, DFT blocks 83, 85, 87, estimator 90, positioning engine 110, IMU 120, and TIP generator 130. However, the mode of operation of FIG. 3 relies on two additional components-namely a frequency control selector 140 and a code phase control selector 150.

The frequency control selector 140 receives two inputs. One input is coupled to an output of the LoS delay and Doppler estimator 90. This provides the frequency control selector 140 with the Doppler estimate produced by the measurement engine (that is, by the estimator 90). A second input is coupled to an output of the TIP generator 130. This provides the frequency control selector 140 with the Doppler estimate produced from the output of the positioning engine 110 (based in part on inertial measurements from the IMU 120). For each epoch—that is, for each coherent integration by the DFT blocks 83, 85, 87—the frequency control selector 140 selects one of the two Doppler estimates to control the carrier generator 42 (and the code generator 52, via the carrier aiding block 70). When the frequency control selector 140 selects the Doppler estimate produced by the estimator 90, the frequency control is achieved in a manner similar to that of FIG. 1, with closed-loop control. When the frequency control selector 140 selects the Doppler estimate produced by the TIP generator 130, the frequency control is achieved in a manner similar to that of FIG. 2.

The code phase control selector 150 functions in a similar way. It receives two inputs. One input is coupled to an output of the LoS delay and Doppler estimator 90. This provides the code phase control selector 150 with the code phase estimate produced by the measurement engine (that is, by the estimator 90). A second input is coupled to an output of the TIP generator 130. This provides the code phase control selector 150 with the code phase estimate produced from the output of the positioning engine 110 (based in part on inertial measurements from the IMU 120). For each epoch—that is, for each coherent integration by the DFT blocks 83, 85, 87—the code phase control selector 150 selects one of the two code phase estimates to control the code generator 52. When the code phase control selector 150 selects the code phase estimate produced by the estimator 90, the code phase control is achieved in a manner similar to that of FIG. 1, with closed-loop control. When the code phase control selector 150 selects the code phase estimate produced by the TIP generator 130, the code phase control is achieved in a manner similar to that of FIG. 2.

Both the estimator 90 and the TIP generator 130 produce code phase estimates at the lower rate (for example, 1 Hz). They both produce Doppler estimates at the higher rate (for example, 50 Hz). The frequency control selector 140 and the code phase control selector 150 can select between their inputs independently. This makes the operation mode of FIG. 3 as flexible and adaptable as possible. In this context, the operation mode of FIG. 2 can also be seen as a simplified version of that of FIG. 3.

The selections of which estimates are used to drive the NCOs 44 and 54 be made in a variety of ways. According to the present example, the selection is made based on an examination of the consistency between the pairs of estimates.

The frequency control selector 140 compares the Doppler estimate produced by the estimator 90 with that produced by the TIP generator 130. If the two estimates are in agreement (that is, if an absolute difference between them is less than a predetermined threshold) then the frequency control selector 140 selects the Doppler estimate produced by the estimator 90 for the current epoch. Otherwise, the frequency control selector 140 selects the Doppler estimate produced by the TIP generator 130.

The code phase control selector 150 compares the code phase estimate produced by the estimator 90 with that produced by the TIP generator 130. If the two estimates are in agreement (that is, if an absolute difference between them is less than a predetermined threshold) then the code phase control selector 150 selects the code phase estimate produced by the estimator 90 for the current epoch. Otherwise, the code phase control selector 150 selects the code phase estimate produced by the TIP generator 130.

Without wishing to be bound by theory, it is believed that the Doppler and code phase estimates produced by the measurement engine (that is, by the estimator 90) will usually be more accurate than those produced by the TIP generator 130, provided signal reception conditions are good. When signal reception conditions are bad, the measurement engine may begin to lose its lock on the GNSS signal, and one or both estimates produced by the measurement engine may therefore drift away from those produced by the TIP generator 130. By detecting this, according to the operation mode of FIG. 3, the system can switch to the more reliable estimate(s) produced by the TIP generator 130.

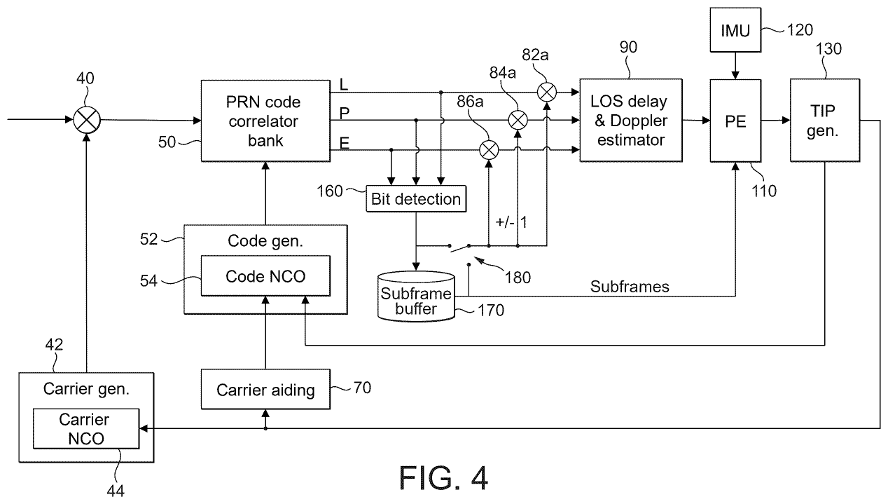

The block diagram of FIG. 4 illustrates a variant of the example of FIG. 2. The main difference between the example of FIG. 2 and the example of FIG. 4 is in the way in which bit detection and removal is performed. In FIG. 4, the bit removal blocks are depicted explicitly as multipliers 82a, 84a, 86a. Each multiplier receives as input one of the complex correlator outputs (late, prompt, and early, respectively) from the bank 50 of correlators. Each multiplier 82a, 84a, 86a multiplies the respective complex correlator output by either +1 or −1, according to the data bit believed to be modulated on the complex correlator output. The values of these data bits may be determined in one of several ways. When the values of the data bits are not available, the multipliers 82a, 84a, 86a may resort to sample squaring (as discussed in greater detail later below).

A GNSS receiver operating in the mode of operation of FIG. 4 includes a bit detector 160 and a buffer 170. A switch 180 is also provided. The switch 180 is configured to selectively couple either an output of the bit detector 160 or an output of the buffer 170 to the multipliers 82a, 84a, 86a.

As shown in the diagram, the inputs of the bit detector 160 are coupled to the outputs of the bank 50 of correlators. The bit detector 160 receives the complex-valued correlator outputs and evaluates the average signal-to-noise ratio of each tap (that is, late, prompt, and early, respectively). The correlator tap with the highest signal-to-noise ratio is selected for bit detection. The complex IQ samples from this tap are further integrated for the duration of one bit (for example, 20 ms). Here, it is assumed that bit synchronisation has already been achieved, such that the timing of the bit edges is known.

The result of the integration is a complex-valued result associated with each bit period. The bit detector 160 compares the complex valued integration results for successive bit periods to detect bits. Phase shift keying (PSK)—in particular, binary phase shift keying (BPSK)—is commonly used to modulate data messages on GNSS signals. Accordingly, in some examples, the bit detector detects the bit value by comparing the complex phase angle of the integration results associated with successive bit periods. When the phase shift (phase angle difference) is below a threshold (for example, 90°) one bit value (for example, +1) is detected; otherwise, the opposite bit value (for example, −1) is detected.

The bits detected by the bit detector 160 may be stored in the buffer 170, for later use. An output of the buffer 170 is coupled to the positioning engine 110. Once enough bits have been detected and stored, the positioning engine 110 can decode the navigation message and evaluate the ephemeris.

In certain circumstances, the “freshly” detected bits from the bit detector 160 may be passed via the switch 180 directly to the bit removal multipliers 82a, 84a, 86a, where they are used to wipe off the bits from the complex-valued correlator outputs. (Note that the correlator outputs may be provided to the multipliers 82a, 84a, 86a, with a suitable delay—not indicated explicitly in FIG. 4—to compensate for any delay in the bit detector 160 and align the inputs to the multipliers correctly.)

In certain circumstances, the detected bits from the bit detector 160 are stored in the buffer when they are initially detected and they are retrieved later (by the switch 80 selecting the output of the buffer) to be used by the multipliers 82a, 84a, 86a for bit wipe-off.

Concluding, the detected bits (with values +1 and −1) are fed into all the multipliers 82a, 84a, 86a to remove the bits. If the bits are not detected but retrieved from a buffered subframe, they are also fed into all the bit removal blocks in the form of the multipliers 82a, 84a, 86a.

The selection of whether to use “freshly” detected bits (from the bit detector 160) or buffered bits (from the buffer 170) for bit wipe-off can be made in various ways. According to the present example the selection is based partly on signal quality and partly on the subframe number.

When carrier to noise density ratio (C/No) is high and bit detection is therefore reliable, the switch 180 selects freshly detected bits from the bit detector 160. Whether C/No is “high” can be determined by comparing it with a predetermined threshold.

When C/No is low (e.g., below the predetermined threshold), and bit detection is consequently less reliable, the bit wipe-off is controlled according to the subframe number. If the current subframe is a repeating subframe (sometimes referred to as a periodic subframe), whose bits have previously been stored in the buffer 170, then the switch 180 selects the output of the buffer 170. The previously buffered data bits are retrieved from the buffer 170 and used for bit wipe off by the multipliers 82a, 84a, 86a.

Repeating subframes are those transmitted repeatedly by a satellite within a specific interval. For example, in the case of GPS L1 C/A, subframes 1, 2, and 3 fall into this category. They are repeatedly transmitted with a period of 30 s over an interval of about two hours. This interval (in which the contents of the repeating subframe are predictable from one or more previous instances of the same subframe) defines a validity interval, during which a buffered copy of the repeating subframe can be used for bit wipe-off. Beyond the validity interval (of, for example, two hours) any subframes stored in the buffer are replaced by newly decoded subframes.

Note that it is not required that all instances of a repeating subframe are identical, over the validity interval. The repetition period may correspond to an integer number of subframe instances, which repeat again and again in the same sequence for the duration of the validity interval.

In contrast to repeating subframes, non-repeating subframes contain distinct payloads, which prevent the GNSS receiver from deducing the payload of a current instance of a subframe based solely on a previously buffered instance of that subframe. Each instance of such a subframe has its own unique contents.

Note that the GPS L1 C/A signal is merely an example. Repeating subframes also arise in other GNSS signals/constellations.

In some examples according to the present disclosure, repeating subframes that have a relatively short period of repetition may be preferred to those that have a relatively long period. The longer the period of repetition, the less frequently a given unique instance of the subframe is repeated. This may diminish the benefits of buffering the subframe, in the sense that the rate of re-use is low. Meanwhile, the memory capacity required may increase, because the number of unique instances of the subframe that are needed to fully characterise the repetition-period increases.

In some examples, the GNSS receiver may be configured to buffer (and re-use) subframes that have a repetition-period that is less than one minute. This threshold includes, for example, subframes 1, 2, and 3 of the GPS L1 C/A signal. The almanac subframes of the GPS L1 C/A signal repeat with a period of 12 minutes. They are still repeating subframes, according to the definition given above. However, they are excluded from buffering and re-use if the one-minute threshold (or any other threshold less than 12 minutes) is applied.

When C/No is low (e.g., below the predetermined threshold), and the current subframe is a non-repeating subframe (or a repeating subframe that has not been buffered), the multipliers 82a, 84a, 86a may resort to sample-squaring. This incurs a loss of sensitivity, but it may be preferable to using unreliable detected bit values for wipe off.

By wiping off bits differently in different circumstances, the present example can help to ensure that bit wipe-off is performed as completely and as accurately as possible. This can help to prepare the data-free complex-valued correlation results (output by the multipliers 82a, 84a, 86a) for long integration, which in turn can help to increase the sensitivity of the GNSS receiver. In the example of FIG. 4, the data-free complex-valued correlation results (output by the multipliers 82a, 84a, 86a) are passed directly to the LoS delay and Doppler estimator 90, which integrates them and produces at least one GNSS measurement from them. (Alternatively, if signal lock has previously been lost, the estimator 90 may indicate detection of a GNSS signal, rather than immediately producing a GNSS measurement for the current epoch.)

In the example of FIG. 4, the measurement (or declaration of signal lock) is passed to the positioning engine 110 as before. Note that the DFT blocks 83, 85, 87 are omitted from the example of FIG. 4, but they could be included in other examples (between the multipliers 82a, 84a, 86a and the LoS delay and Doppler estimator 90).

The bit detector 160 may be configured to perform a cyclic redundancy check (CRC) on the bits that it detects and to store the bits in the buffer 170 only if the check is successful. This can help to ensure that only correctly detected bits are stored in the buffer 170.

Each subframe stored in the buffer 170 has an associated validity period. After the validity period expires, the stored subframe is no longer used for bit wipe-off. Once the bits of a fresh instance of the subframe have been detected by the bit detector 60 (and they have passed the CRC check) that subframe will once again be available for bit wipe-off.

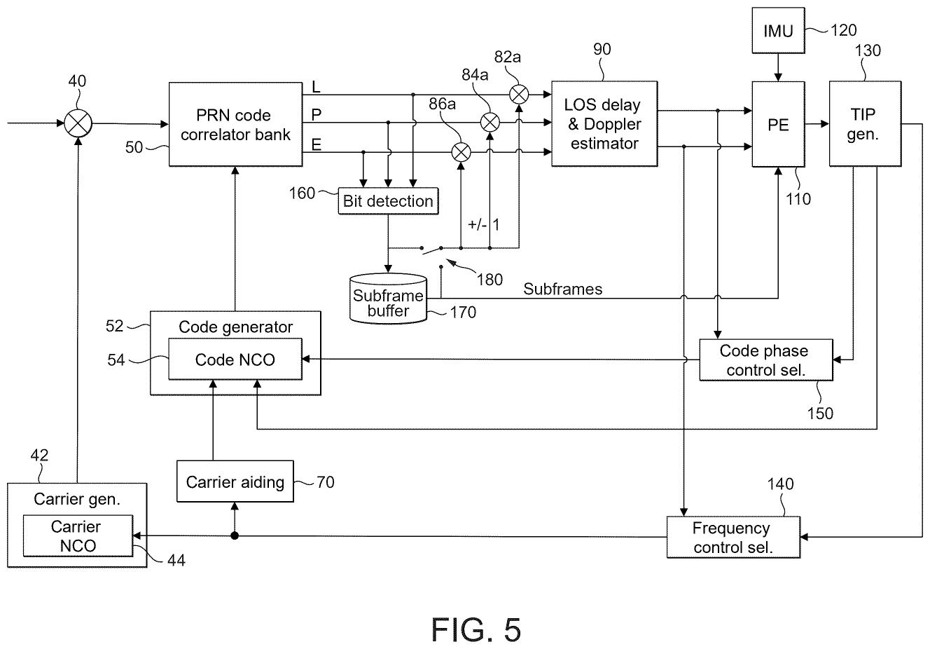

The block diagram of FIG. 5 illustrates an example combining the improved bit detection and wipe-off of FIG. 4 with the mode selection of FIG. 3. This operates in the same way described above for the example of FIG. 3, except that the bit detection and removal is implemented in the manner described for the example of FIG. 4.

According to various aspects of the present disclosure, the operation modes can be used in various configurations. For instance, a GNSS receiver may use exclusively the operation mode of FIG. 4, or exclusively the operation mode of FIG. 5. According to some examples, a GNSS receiver may be configured to implement more than one operation mode. For instance, a GNSS receiver may be configured to implement the operation mode of FIG. 1 and the operation mode of FIG. 4 and select between them in different circumstances. Alternatively, a GNSS receiver may be configured to implement the operation mode of FIG. 1 and the operation mode of FIG. 5 and select between them in different circumstances.

In some examples, a GNSS receiver may be configured to implement three operation modes and select between them. In one example, if C/No is greater than 37 dB-Hz, or if carrier phase lock is intact, or if the residual is below a predetermined threshold, the signal reception conditions may be categorized as being of good quality for that GNSS signal. In this case Mode 1 (FIG. 1) may be selected for that signal. Mode 3 (FIG. 3) may be selected if the signal is of poor quality (that is, not good quality). Mode 2 (FIG. 2) may be selected if the signal is of poor quality, but the receiver is trying to conserve power (since Mode 2 can be considered a simplified version of Mode 3). The variant illustrated in FIG. 4 may be selected in place of Mode 2 (FIG. 2). The variant illustrated in FIG. 5 may be selected in place of Mode 3. It should be understood that the mode selection can be made independently for each GNSS signal being tracked by the receiver. For instance, for a given epoch, Mode 1 may be selected for one or more GNSS signals, and Mode 2 (or Mode 3) may be selected for one or more other GNSS signals.

An optional refinement may be applied, when obtaining Doppler estimates from the TIP generator (based on the output of the positioning engine 110), in the modes of operation of FIGS. 2 and 3 (and their variants, in FIGS. 4 and 5). Although the TIP generator 130 supplies a Doppler estimate at the higher rate (e.g., 50 Hz), which is the same rate as the estimator 90, there is additional latency in the Doppler estimates produced by the TIP generator 130. One way to help compensate for this is to extrapolate, from the most recent estimates of Doppler frequency, what the Doppler frequency is expected to be at the time of the next update to the carrier NCO 44 and code NCO 54.

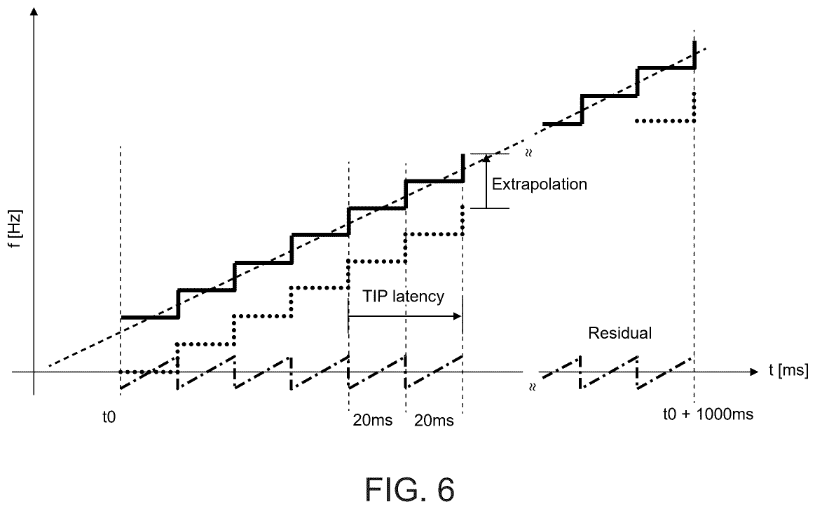

According to the present implementation, Doppler estimates are extrapolated assuming constant acceleration. This assumes a linear relationship between Doppler frequency and time. The instantaneous acceleration (or rate of change of the Doppler frequency) is estimated by comparing the two most recently available Doppler estimates. The TIP generator 130 then extrapolates from the most recent Doppler estimate using the acceleration estimate, to predict the Doppler frequency at the moment the NCOs 44, 54 are next set. This is illustrated in FIG. 6, for a 50 Hz update rate of the NCOs, and an assumed latency of 40 ms. The plots in FIG. 6 represent an interval equal to the coherent integration time of the DFTs (in this example, 1 s).

The dashed line represents the assumed linear function of Doppler frequency with respect to time. In the example illustrated, the frequency is increasing over time. This corresponds to a situation where the GNSS receiver is accelerating towards the satellite. The Doppler frequency is approximated by a piecewise constant function, since the Doppler is estimated, and the NCOs are updated every 20 ms. Due to the latency in the system (40 ms, equal to two of the piecewise constant intervals) the Doppler estimates (dotted line) always lag behind the true Doppler frequency (dashed line). When the frequency is increasing, this means that the Doppler estimates lag below the true Dopper. This is shown in FIG. 6—the lower staircase function (dotted line) represents the Doppler estimates with 40 ms latency. To compensate for this latency, the TIP generator extrapolates upwards, to take account of the (expected) further increase in Doppler frequency over the latent period. The extrapolation assumes that the Doppler frequency will continue to exhibit the same rate of change with respect to time. The extrapolated Doppler estimates are represented by the upper staircase function (solid black line), which better approximates the true (linearly increasing) Doppler frequency. The triangular function (shown in dash-dot) around 0 Hz is the residual Doppler frequency, seen in the complex correlator outputs.

In the current implementation of the GNSS receiver, the blocks 20, 30, 40, 42, 44, 50, 52, and 54 are implemented in dedicated hardware. Blocks 62, 64, 70, 82-87, 82a, 84a, 86a, 90, 110, 120, 130, 140, 150, 160, and 180 are currently implemented in software running on a processor of the GNSS receiver. However, they could alternatively be implemented in dedicated hardware. The buffer 170 is implemented in a memory—for example, a random-access memory (RAM).

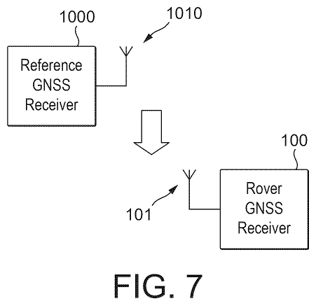

FIG. 7 is a block diagram illustrating a differential GNSS (DGNSS) system according to an example. The DGNSS system comprises a rover GNSS receiver 100 and a reference GNSS receiver 1000. The rover GNSS receiver 100 has an antenna 101 for receiving signals from the reference GNSS receiver 1000. The reference GNSS receiver 1000 has an antenna 1010 for transmitting signals to the rover GNSS receiver 100. In general, the rover GNSS receiver 100 may implement any or all of the modes described above with reference to FIGS. 1-5. Those skilled in the art will be familiar with the general principles of DGNSS and they need not be described further here.

Of particular interest are variants of the operation modes illustrated in FIG. 4 and FIG. 5, which are adapted for use in the context of DGNSS. In FIGS. 4 and 5, bits were detected by a bit detector 160 incorporated in the (rover) GNSS receiver 100. However, to the extent that the same satellites are visible, and the same GNSS signals are received at both the reference GNSS receiver 1000 and the rover GNSS receiver 100, it is also possible that bit detection may be performed at the reference GNSS receiver 1000. The reference GNSS receiver 1000 may be able to perform bit detection more reliably for various reasons. For instance, it may be static and located with a good view of the sky (for example, in an elevated position away from obstacles and sources of interference). The reference GNSS receiver 1000 may also have a larger and/or more sensitive GNSS antenna (or GNSS antennas) for receiving GNSS signals. The signal-to-noise ratio observed by a correlator at the reference GNSS receiver 1000 may therefore be higher than that observed by any of the correlators in the bank 50 of the rover GNSS receiver 100. The values of bits detected at the reference GNSS receiver 1000 may be transmitted in real time to the rover GNSS receiver 100, via antennas 1010 and 101. They may be used by the rover GNSS receiver 100 in the same way as the bits detected by the bit detector 160 in FIGS. 4 and 5—stored in the buffer 170 and retrieved later for bit wipe-off, or used as “fresh” detected bits and used directly for bit wipe-off.

The example of FIG. 7 assumes a direct wireless (e.g. RF) link between the two GNSS receivers (between the antennas 1010 and 101). However, this is not essential and not limiting on the scope of the present disclosure. In other examples, the detected bits may be communicated from the reference GNSS receiver 1000 to the rover GNSS receiver 100 via some other channel. For example, both GNSS receivers may have a data connection with a cellular communications network, via which the detected bits can be transferred.

It should be understood that the scope of the present disclosure is not limited to the examples described above. Many variations will be apparent to those skilled in the art, based on the foregoing description.

The 20 ms dwells/integration periods for coherent integration described above may be beneficial; however, the method is not limited in this respect. Longer or shorter integration periods may be chosen. The choice may be based on the signal conditions expected or experienced in use. For example, in highly dynamic scenarios, where the receiver is subject to frequent rapid changes in speed and/or direction, a shorter coherent integration period may be desirable, to better cope with the signal dynamics. Conversely, if the receiver is expected to be static, it might be beneficial to extend the coherent integration period—for example, so as to integrate over multiple bit-periods of the GNSS signal.

In the examples above, the measurement engine was described as producing GNSS measurements from the GNSS signal. This is indeed the typical primary purpose of a measurement engine. However, the measurement engine could also (or instead) produce an indication of whether or not the GNSS signal is detected—that is whether a GNSS signal has been acquired, prior to tracking it and/or making GNSS measurements. This may be useful in particular if GNSS signal lock is lost during tracking of a GNSS signal.

Other variations involve the way in which the blocks are implemented. In the example discussed above, certain components were defined in software or software modules running on a processor of the GNSS receiver. However, in other examples, some or all of these units may be implemented in dedicated, fixed-function hardware. Likewise, components that were defined in hardware, according to the examples above, may be defined in software, in other embodiments.

In the claims, any reference signs placed between parentheses shall not be construed as limiting the claim. The word “comprising” does not exclude the presence of elements or steps other than those listed in a claim. However, where the word “comprising” is used, this also discloses as a special case the possibility that the elements or steps listed are exhaustive—that is, the apparatus or method may consist solely of those elements or steps. The word “a” or “an” preceding an element does not exclude the presence of a plurality of such elements. The embodiments may be implemented by means of hardware comprising several distinct elements. In a device claim enumerating several means, several of these means may be embodied by one and the same item of hardware. The mere fact that certain measures are recited in mutually different dependent claims does not indicate that a combination of these measures cannot be used to advantage. Furthermore, in the appended claims lists comprising “at least one of: A; B; and C” should be interpreted as (A and/or B) and/or C.

In flowcharts, summaries, claims, and descriptions relating to methods, the sequence in which steps are listed is not, in general, intended to be limiting on the order in which they are carried out. The steps may be performed in a different order to that indicated (except where specifically indicated, or where a subsequent step relies on the product of a preceding step). Nevertheless, the order in which the steps are described may in some cases reflect a preferred sequence of operations.

Furthermore, in general, the various embodiments may be implemented in hardware or special purpose circuits, software, logic or any combination thereof. For example, some aspects may be implemented in hardware, while other aspects may be implemented in firmware or software, which may be executed by a controller, microprocessor or other computing device, although these are not limiting examples. While various aspects described herein may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments described herein may be implemented by computer software executable by a data processor of the apparatus, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments as discussed herein may be practiced in various components such as integrated circuit modules. The design of integrated circuits is generally a highly automated process. Complex and powerful software tools are available for converting a logic level design into a semiconductor circuit design ready to be etched and formed on a semiconductor substrate.

The invention claimed is:

1. A method of processing a GNSS signal received at a receiver, the GNSS signal containing a data message comprising a plurality of data bits, the method comprising:
obtaining samples of the GNSS signal;
generating a local carrier signal;
generating a local spreading code;
mixing the local carrier signal with the samples to generate carrier-free signal samples;
correlating the carrier-free signal samples with the local spreading code to generate a complex-valued correlation result;
wiping off at least one of the data bits from the complex-valued correlation result, to produce a data-free complex-valued correlation result; and
processing the data-free complex-valued correlation result to produce at least one of: an indication of whether the GNSS signal is detected or not; and a GNSS measurement for the current epoch,
wherein a carrier phase of the local carrier signal is controlled based on a Doppler estimate for the GNSS signal, wherein the Doppler estimate is based on inertial measurements made at the receiver.

2. The method of claim 1, further comprising detecting a data bit based on the complex-valued correlation result.

3. The method of claim 1, further comprising obtaining a data bit detected at a reference receiver.

4. The method of claim 2, wherein wiping off at least one of the data bits from the complex-valued correlation result is based on the detected data bit.

5. The method of claim 4, comprising:
identifying a subframe of the data message that is associated with the detected data bit;
determining that the subframe is not a repeating subframe that has been buffered previously; and
wiping off the at least one of the data bits from the complex-valued correlation result based on the detected data bit, responsive to said determining.

6. The method of claim 4, comprising:
identifying a subframe of the data message that is associated with the detected data bit;
determining a signal quality metric associated with the detected data bit; and
determining that the subframe is not a repeating subframe that has been buffered previously, and that the signal quality metric exceeds a signal quality threshold; and
wiping off the at least one of the data bits from the complex-valued correlation result based on the detected data bit, responsive to said determining.

7. The method of claim 2, further comprising storing the detected data bit in a buffer.

8. The method of claim 7, comprising:
identifying a subframe of the data message that is associated with the detected data bit;
determining that the subframe is a repeating subframe; and
storing the detected data bit in the buffer, responsive to said determining.

9. The method of claim 7, comprising:
identifying a subframe of the data message that is associated with the detected data bit;
determining a signal quality metric associated with the detected data bit;
determining that the subframe is a repeating subframe and that the signal quality metric exceeds a signal quality threshold; and
storing the detected data bit in the buffer, responsive to said determining.

10. The method of claim 1, further comprising retrieving a stored data bit from a buffer, wherein wiping off at least one of the data bits from the complex-valued correlation result is based on the retrieved data bit.

11. The method of claim 10, comprising:
identifying a subframe of the data message that is associated with the at least one data bit to be wiped off;
determining that the subframe is a repeating subframe that has been buffered previously; and
wiping off the at least one of the data bits from the complex-valued correlation result based on the retrieved data bit, responsive to said determining.

12. The method of claim 10, comprising:
identifying a subframe of the data message that is associated with the at least one data bit to be wiped off;
determining a signal quality metric;
determining that the subframe is a repeating subframe that has been buffered previously and that the signal quality metric does not exceed a signal quality threshold; and
wiping off the at least one of the data bits from the complex-valued correlation result based on the retrieved data bit, responsive to said determining.

13. The method of claim 1, wherein the GNSS measurement comprises a code phase of the GNSS signal, and wherein processing the data-free complex-valued correlation results comprises determining the code phase of the GNSS signal based on the data-free complex-valued correlation results.

14. A computer program comprising computer program code configured to cause one or more physical computing devices to perform all the steps of a method as claimed in claim 1 when said computer program is run on said one or more physical computing devices.

15. A Global Navigation Satellite System, hereinafter GNSS, receiver, configured to process a GNSS signal, the GNSS receiver comprising a measurement engine configured to:
obtain samples of the GNSS signal;
generate a local carrier signal;
generate a local spreading code;
mix the local carrier signal with the samples to generate carrier-free signal samples;
correlate the carrier-free signal samples with the local spreading code to generate a complex-valued correlation result;
wipe off at least one of the data bits from the complex-valued correlation result, to produce a data-free complex-valued correlation result; and
process the data-free complex-valued correlation result to produce at least one of: an indication of whether the GNSS signal is detected or not; and a GNSS measurement for the current epoch,
wherein a carrier phase of the local carrier signal is controlled based on a Doppler estimate for the GNSS signal, wherein the Doppler estimate is based on inertial measurements made at the receiver.
